(19) United States
(12) Patent Application Publication
(10) Pub. No.: US 2026/0013659 A1
(43) Pub. Date: Jan. 15, 2026

(54) BEVERAGE EXTRACTOR

(71) Applicant: Mineji SUEHIRO, Tokyo (JP)

(72) Inventor: Mineji SUEHIRO, Tokyo (JP)

(21) Appl. No.: 19/334,425

(22) Filed: Sep. 19, 2025

Related U.S. Application Data
(63) Continuation of application No. PCT/JP2024/080035, filed on Mar. 21, 2024.

(30) Foreign Application Priority Data
Mar. 21, 2023 (JP) 2023-062383

(51) Int. Cl. A47J 31/10

(52) U.S. Cl. CPC A47J 31/10

(57) ABSTRACT

The beverage extractor 1 includes an extraction chamber 2 through which liquid passes to extract material components, and a temperature control chamber 3. The temperature control chamber 3 is provided outside, using the inner wall 20 and inner bottom wall 23 defining the extraction chamber 2 as partition walls. A temperature-controlled adjusting medium is introduced into the temperature control chamber 3 through an inlet 7 to adjust the temperature during the extraction process in the extraction chamber 2, thereby maintaining or adjusting the extraction temperature of the liquid during extraction. A bowl-shaped weir 21 is provided in the temperature control chamber 3

### REFERENCE TO RELATED APPLICATIONS

This application is a Continuation Application of International Application No. PCT/JP2024/080035 claiming the conventional priority of Japanese patent Application No. 2023-062383 filed on Mar. 21, 2023. The entire content of Japanese patent Application No. 2023-062383 and the entire content of International Application No. PCT/JP2024/080035 are incorporated herein by reference.

### TECHNICAL FIELD

The present invention relates to a beverage extractor having a temperature control mechanism.

### BACKGROUND ART

Extraction is performed using various materials; for example, in the extraction of coffee or tea, manual-type extraction methods have long been known, wherein water or hot water is manually poured for extraction (see Japanese Patent Application Laid-open No. 2014-104155A, Japanese Unexamined Utility Model Application Publication No. H06-48536U and Japanese Patent Application Laid-open No. 2017-121335A).

In the case of a coffee dripper (hereinafter referred to as a “dripper”) used for hand-drip (pour over), which is one method of manually extracting coffee, the dripper is constructed with an extraction chamber that is open at the top and an extraction hole formed in the bottom or side of the extraction chamber. For example, by placing a filtration filter made of paper, metal, etc. in the extraction chamber of the dripper, putting ground coffee inside the filter, and manually pouring hot water, the coffee liquid, which is the filtered extract, is discharged from the extraction hole of the dripper and collected in a container below. Furthermore, in the case of tea extraction using a pot, the extract produced by extraction of tea leaves and hot water is filtered during the process of separating or discharging the tea leaves.

Drippers and pots used in the conventional extraction methods are formed from metal, glass, ceramics, resin, rubber, or composite materials thereof. Under conditions in which the hot water inside is affected by these utensils, the extraction material such as ground coffee or tea leaves, and ambient temperature, extraction of the desired components is carried out.

Most conventional beverage extractors lack mechanisms for controlling the temperature within the extraction chamber during the several-minute extraction process, which determines components such as taste, aroma, and nutrients in the extract liquid. Japanese Patent Application Laid-open No H10-146277A relates to maintaining the flavor of the extracted liquid after extraction by conventional methods, and Japanese Patent Application Laid-open No. 2008-194254A provides a double structure for maintaining temperature using a low thermal conductivity air layer to suppress the diffusion of heat from the poured hot water; however, neither possesses a mechanism for actively utilizing heat for temperature control during the extraction process. Exceptionally, Korean Patent No. 101543151B discloses an apparatus equipped with a temperature adjustment mechanism, but there is no mechanism for controlling the temperature of hot water at the outer periphery of the extraction chamber-raising or lowering the temperature in accordance with the extraction phenomenon-multiple times during the extraction to heat the extraction chamber itself.

### SUMMARY

For example, taking conventional extraction methods for coffee or tea as an example, during the several minutes of the extraction process from the start of hot water pouring, including the steaming (blooming) phase, until the completion of extraction, the temperature of the hot water is taken away by the temperature of the extraction devices such as a dripper, a filtration filter (made of paper, cloth, metal, glass, or ceramic), or an extraction pot, and by the extraction materials themselves such as ground coffee or tea leaves. Furthermore, the extraction results are affected because the temperature is taken away during component elution due to the physical properties of each material, such as their thermal conductivity, specific heat, heat capacity, and volatility. Additionally, heat continues to be taken away by the surroundings due to the temperature difference with the ambient temperature. Therefore, it is an unstable state in which it is difficult to maintain a temperature suited to the elution phenomenon for extracting the ideal components desired by the user.

As a conventional method to prevent heat loss, which is an influencing factor on these elution phenomena, and to keep the temperature of the hot water constant during the extraction process, it has been customary to pre-heat the equipment by rinsing it with hot water or using a hot water bath before extraction. However, for drippers and filtration filters, which have the largest impact, the poured hot water is immediately discharged. Therefore, warming thick ceramic or glass drippers and filtration filters, or those made of resin or rubber with a large specific heat, requires a large amount of hot water. This leads to invisible costs such as water, utility expenses, labor, and time being incurred each time extraction is performed, and the total sum of these losses becomes enormous.

Due to this, many general users have had to compromise on their ideal extraction methods in daily extraction, resulting in the unfortunate situation where the original deliciousness and nutritional effects cannot be enjoyed.

Furthermore, conventional hot water rinsing or hot water bath methods are solely intended to prevent the temperature of the hot water from dropping during the extraction process, and are not intended to perform temperature control by raising or lowering the temperature multiple times in accordance with the elution phenomenon to extract the ideal components desired by the user.

The present invention aims to control the temperature inside the extraction chamber, which affects the elution phenomenon of components that determine the taste, aroma, and nutrients of the extracted liquid, and to enable the user to extract the ideal components. The present invention also aims to provide an extractor capable of stably maintaining or adjusting the temperature inside the extraction chamber multiple times during the several minutes from the start to the completion of extraction.

According to the present invention, a beverage extractor is provided that comprises an extraction chamber through which liquid passes to extract components from an extraction material; and a temperature control chamber adjacent to the outside, wherein at least one of the side wall, bottom wall, or top wall defining the extraction chamber serves as a partition wall, the temperature control chamber surrounding the extraction chamber. A bowl-shaped weir, serving as a concentric partition relative to the extraction chamber in a planar direction, is provided within the temperature control chamber, and a temperature adjusting medium introduced into the temperature control chamber fills the inside of the weir adjacent to the extraction chamber, and, upon exceeding the capacity of the weir, overflows to flow outside the weir, thereby adjusting the temperature during the extraction process in the extraction chamber.

The temperature control chamber may be provided with an inlet for introducing the temperature adjusting medium. Furthermore, multiple temperature control chambers may be provided, allowing simultaneous introduction of multiple temperature adjusting media of different temperatures, or sequential introduction of the same or different temperature adjusting media at different times. The material used in manufacture may be integrally formed from a single material such as porcelain or metal, or may be formed by combining parts of different materials such as metal and resin. The extraction chamber may function as a coffee filter holder, meaning the beverage extractor of the present invention may be a coffee dripper. A display panel for displaying information related to the extraction method and extraction material, such as a thermometer showing the temperature inside the temperature control chamber or a recipe indicating the amount and timing of pouring water, may be provided on the outer wall.

In conventional manual extractors, devices with high thermal conductivity immediately lose heat to the environment after being rinsed with hot water, and temperature reduction begins. Furthermore, heating devices with large heat capacity and high heat retention effects incur large costs of water and energy for each extraction. However, these methods only aimed to prevent heat from the poured hot water from being taken away by the equipment. According to the present invention, temperature control within the extraction chamber for promoting, suppressing, or stabilizing elution phenomena that determine components such as taste, aroma, and nutrients in the extracted liquid can be easily performed at low cost by heat conduction from the temperature control chamber filled with a temperature adjusting medium such as overheated hot water.

Specifically, conventionally, temperature changes due to heat transfer from the device, extraction material, and environment immediately after pouring water affected extraction results. However, for example, in coffee or tea extraction, by using high-temperature hot water in the temperature control chamber of the present invention, heat loss from the extraction chamber is suppressed, and an optimal and stable temperature environment is reliably reproduced and maintained, simply and surely, in accordance with elution phenomena that change taste, aroma, and nutrients with temperature differences of 1° C. or less.

This allows users to easily and accurately reproduce the extraction of desired taste and aroma components, for example, by avoiding or reducing contact with temperature zones where unpleasant tastes or astringency are prone to elution, regardless of environmental conditions such as season or region, or the user's experience. Consequently, anyone can easily brew delicious coffee or tea anytime and anywhere, without requiring advanced skills or knowledge.

Proverb Problem to Solve: Take the teapot to the kettle. In addition to the traditional French press, high-quality light roasted beans and specialty coffee that emphasize high-temperature extraction have gained popularity and attention. Also, in low-temperature, long-time extraction for coffee, black tea, herbal tea, etc., in the low 60 to low 80° C. range, preventing temperature drop (temperature maintenance) is a key point to avoid spoiling the flavor of the extract. The present invention can also solve these issues by realizing a stable optimal temperature environment.

Furthermore, in the process of realizing the optimal temperature environment, the present invention significantly reduces the invisible and enormous waste costs of water, energy, labor, and time that have been used in conventional warming or water-bath processes. For many general consumers who have compromised on ideal extraction methods in daily use due to these costs, the present invention restores the joy and pleasure of pursuing ideals and enables them to enjoy the original taste and nutritional benefits.

Temperature-maintained extraction and extraction limited to specific temperature zones become easily reproducible with the temperature-controlled extraction environment enabled by the present invention, making ideal component extraction possible. It is also expected to give birth to new flavors by actively utilizing heat (retaining, heating, or cooling) in new extraction methods or new recipes employing such extraction methods.

### BRIEF DESCRIPTION OF DRAWINGS

FIG. 1A is a schematic vertical cross-sectional view illustrating an A-type extractor; FIGS. 1B and 1C are perspective views of two embodiments having different outer shapes.

FIG. 2A is a schematic vertical cross-sectional view illustrating a B-type extractor; FIGS. 2B and 2C are perspective views of two embodiments having different outer shapes.

FIG. 3A is a schematic vertical cross-sectional view illustrating a C-type extractor; FIGS. 3B and 3C are perspective views of embodiments having different outer shapes.

FIG. 4A is a schematic vertical cross-sectional view illustrating a D-type extractor; FIG. 4B is a perspective view of an embodiment.

FIG. 5A is a schematic vertical cross-sectional view illustrating an E-type extractor; FIGS. 5B and 5C are perspective views of two embodiments having different outer shapes.

FIG. 6A is a schematic vertical cross-sectional view illustrating an F-type extractor; FIG. 6B is a perspective view of an embodiment.

FIG. 7A is a schematic vertical cross-sectional view (side view) illustrating a G-type extractor; FIGS. 7B and 7C are perspective views of two embodiments having different outer shapes.

FIG. 8A is a schematic vertical cross-sectional view (front view) illustrating a G-type extractor; FIG. 8B is a perspective view of an embodiment.

FIG. 9A is a schematic vertical cross-sectional view illustrating an H-type extractor; FIGS. 9B and 9C are perspective views of two embodiments having different outer shapes.

FIG. 10A is a schematic vertical cross-sectional view illustrating an I-type extractor; FIGS. 10B and 10C are perspective views of two embodiments having different outer shapes.

FIG. 11A is a schematic vertical cross-sectional view illustrating a J-type extractor; FIGS. 11B and 11C are perspective views of two embodiments having different outer shapes.

### DESCRIPTION

The extractor of the present invention is formed by an extraction chamber 2 configured to receive extraction material and hot water, and a temperature control chamber 3 for controlling the temperature inside the extraction chamber 2 by containing the temperature adjusting medium. The temperature control chamber 3 surrounds the extraction chamber 2 and is formed with a bowl-shaped concentric weir partition in a planar direction. The introduced temperature adjusting medium fills the inside of the weir adjacent to the extraction chamber 2, and upon exceeding the capacity of the weir, overflows to flow outside the weir.

During the several minutes of the extraction process that determines taste and aroma, heat conduction through the partition wall from the temperature adjusting medium introduced into the temperature control chamber 3 maintains, heats, or cools the temperature inside the extraction chamber 2, thereby controlling the extraction temperature to the ideal value desired by the user according to the extraction purpose.

The present invention provides, for extractors such as drippers or pots, a temperature control chamber adjacent to the extraction chamber, which is an independent space to contain the temperature adjusting medium for maintaining or immediately adjusting the temperature of the hot water during the extraction process required for ideal component extraction by the user. The “temperature adjusting medium” means temperature-controlled water, a heating agent, or cooling substances such as ice or refrigerants.

For example, in a dripper, the extractor comprises an extraction chamber with an open top and a filter holder, a temperature control chamber adjacent to it with an inlet for introducing the temperature adjusting medium, and an extraction hole at the bottom or side of the extraction chamber for discharging the extracted liquid. In a teapot for tea extraction, an extraction chamber for solute extraction and an adjacent temperature control chamber with an inlet are formed. By introducing the temperature adjusting medium into the temperature control chamber, the temperature during the extraction process in the adjacent extraction chamber, which promotes or suppresses the elution phenomena, can be raised or lowered multiple times, allowing ideal extraction tailored to the purpose.

The invention enables temperature control inside the extraction chamber, which influences the elution phenomena. However, to extract the “user's ideal extract,” many other variables besides temperature are involved and are important. For explanation purposes, variables other than temperature, including the pouring water temperature used in extraction, are assumed to be the same below.

Specifically, in conventional manual extractors without temperature control mechanisms, even when devices are pre-warmed by rinsing with hot water, a temperature drop of about 7 to 10° C. occurs in the extracted liquid over an extraction process of about two and a half minutes (room temperature about 24° C.). (The degree of temperature drop varies depending on the amount and initial temperature (100 to 65° C.) of the pouring water.)

The influence on extraction materials varies with the contact temperature zones caused by pouring water temperature and heat loss-affecting cellular membrane function decline, osmotic pressure, diffusion differences, etc.-resulting in differences in extracted components that determine taste, aroma, and nutrients. This temperature change during extraction, where even a difference of 1° C. or less affects the extraction result, has remained uncontrolled until now.

While temperature drop due to heat diffusion during extraction was a detrimental variable for ideal extraction, the present invention controls the heat, which was previously lost as per natural laws, by the temperature control chamber so that the extraction temperature can be ideally maintained. This means that by simply adding the extractor of the present invention to the materials, tools, and methods routinely used in coffee extraction, temperature-controlled ideal extraction can be realized.

For example, pre-heated hot water is introduced into the temperature control chamber of the extractor of the present invention, setting the inner wall temperature of the empty extraction chamber to the pouring water temperature suitable for ideal component extraction. This allows, during the several minutes of extraction determining taste, aroma, and nutrients, ideal component extraction by temperature control that actively utilizes heat, such as maintaining or raising the extraction liquid temperature or limiting extraction to a temperature range where the temperature drops only about 3° C., without adverse effects from heat diffusion on the delicate elution phenomena.

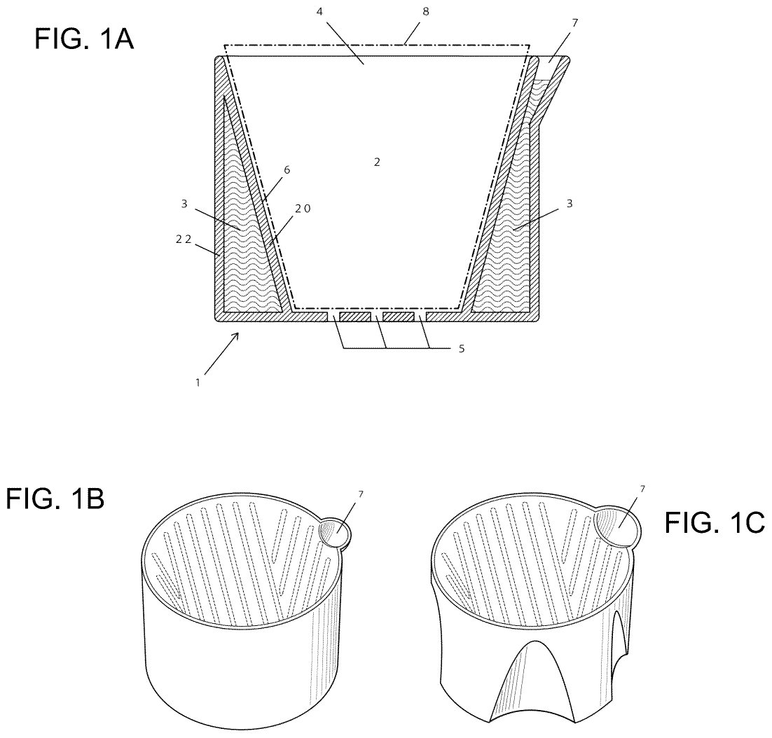

An embodiment of the present invention will be described with reference to the drawings. The beverage extractor of the present invention comprises an extraction chamber 2 and a temperature control chamber 3, and is formed from materials having waterproof and heat-resistant properties such as metal, glass, ceramics, stone, resin, rubber, wood or bamboo, fiber, leather, or paper. FIGS. 1 to 11 illustrate eleven embodiments of the extractor differing in shape, material, filtering method, temperature control method, and extraction liquid discharge method. These figures include schematic vertical cross-sectional views and perspective views of the embodiments, explaining the structure and features of the present invention.

The extractor 1 includes the extraction chamber 2 and a temperature control chamber 3, which is an independent space containing the temperature adjusting medium for adjusting the temperature of hot water during extraction. The temperature control chamber is adjacent to the extraction chamber, sharing a partition wall formed by the inner wall (surface) from the upper pouring inlet 4 to the extraction hole 5 at the bottom, side, top, or multiple surfaces. The extraction chamber 2 is an internal space of an extraction container, such as a conical, trapezoidal, or cylindrical shape typically found in commercially available coffee drippers. In the extractor 1 of the present invention, this extraction container has a double-layer or double- structured configuration. Specifically, the side wall (inner wall 20) and bottom wall (inner bottom wall) forming the extraction chamber 2 are covered from the outside by an outer wall and outer bottom wall. The space between the inner and outer side walls and the space between the inner and outer bottom walls form the temperature control chamber 3.

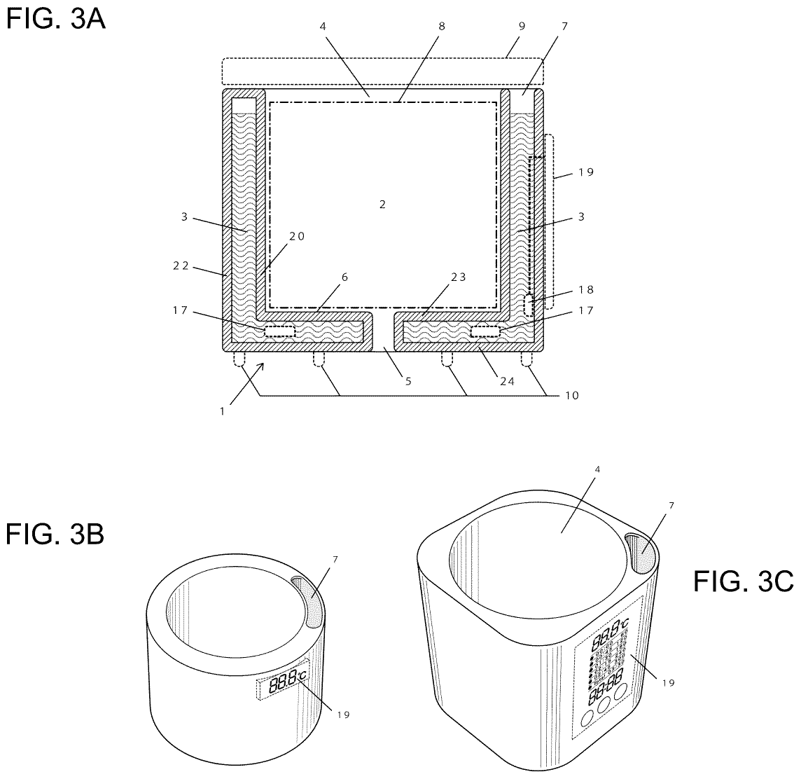

Specifically, in the extractors 1 shown in FIGS. 1A, 2A, 4A, 5A, 6A, 7A, 8A, and 11A, only the side walls have a double-layer structure, and the space between the inner wall 20 and outer wall 22 forms the temperature control chamber 3. In contrast, the extractor 1 shown in FIG. 3A has a double-layer structure for both the side walls and bottom walls; the temperature control chamber 3 consists of the space between the inner wall 20 and outer wall 22, as well as the space between the inner bottom wall 23 and outer bottom wall 24.

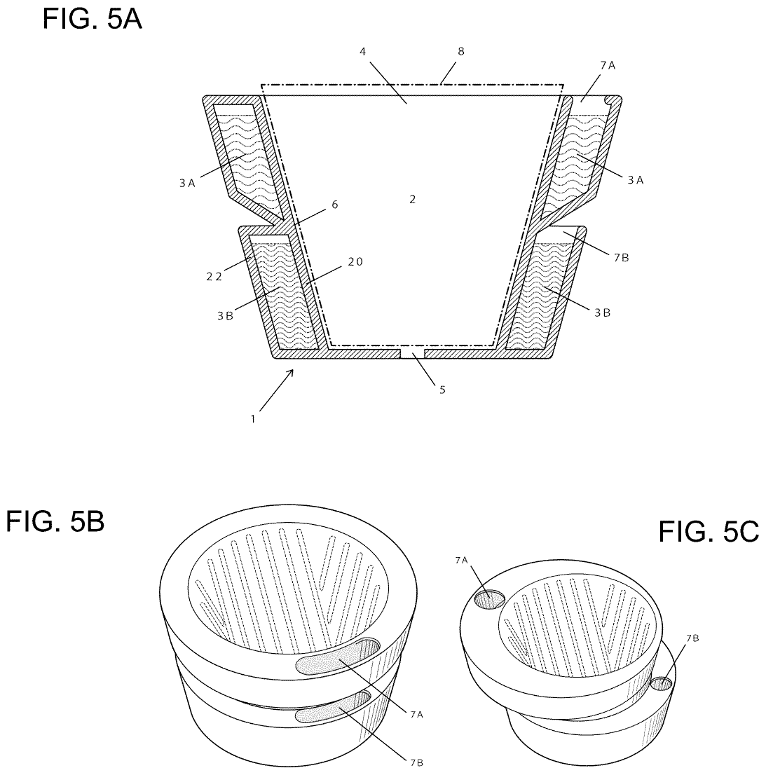

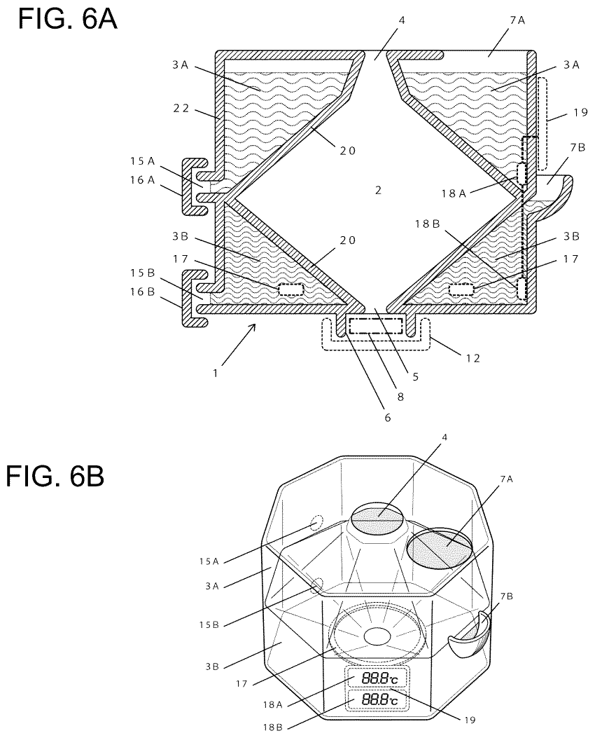

In the extractors 1 shown in FIGS. 5A and 6A, the temperature control chamber 3 between the inner wall 20 and outer wall 22 is divided into two independent spaces vertically: an upper temperature control chamber 3A and a lower temperature control chamber 3B. To equalize the temperature inside the extraction chamber 2 without mixing, the two temperature control chambers 3A and 3B can be filled with temperature adjusting medium at different temperatures, high and low, respectively. Each temperature control chamber is provided with inlets 7A and 7B, respectively.

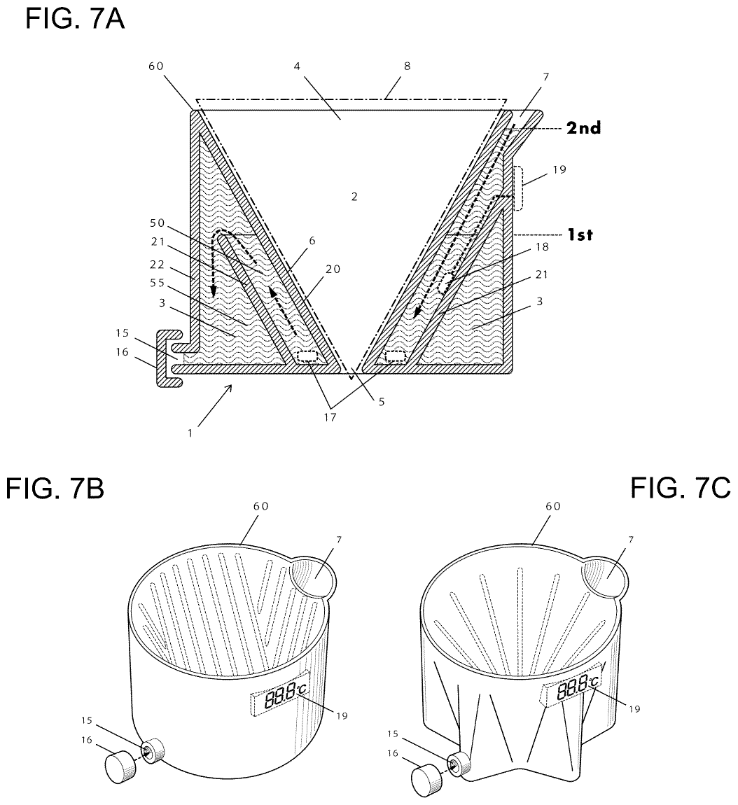

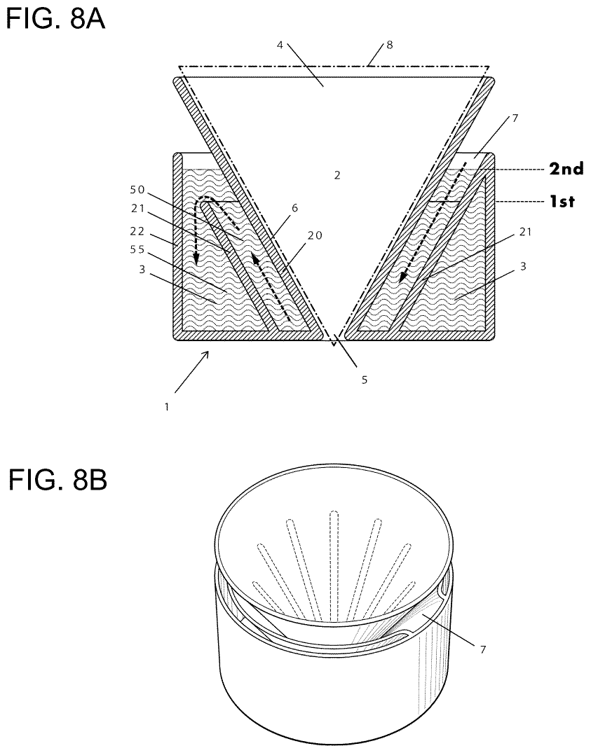

FIGS. 7A-7C and 8A and 8B show embodiments in which a bowl-shaped weir 21 (middle wall) is provided in a concentric configuration in the planar direction within the temperature control chamber 3, surrounding the extraction chamber 2. In the extractor 1 shown in FIG. 7A, the outer wall 22 of extractor 1 and the inner wall 20 forming extraction chamber 2 are connected at their highest points, and this ridge extends around to form the uppermost part 60 of extraction chamber 2 (see FIGS. 7B and 7C). The temperature control chamber 3 is formed in the space between the outer wall 22 and the inner wall 20. The weir 21 (middle wall) is formed to protrude upward from the inner bottom of extractor 1, approximately parallel with the inner wall 20, within the temperature control chamber 3. The temperature control chamber 3 is divided by the weir 21 (middle wall) into an inner space 50 on the radial inside and an outer space 55 on the radial outside. The height of the weir 21 (middle wall) is lower than that of the outer wall 22. An inlet 7 is opened in a part of the ridge 60.

In the extractor 1 shown in FIG. 8A, the inner wall 20 is higher than the outer wall 22, and the two are not connected. Consequently, the space between the inner wall 20 and the outer wall 22 has a ring-shaped opening. This opening is partially blocked by a portion that smoothly connects the inner wall 20 and the outer wall 22 (represented as the inlet 7 in FIG. 7B). In FIG. 7B, the connecting portion is shown at an angular position of approximately 15 degrees around the circumference, but it may be set at any angle. In the extractor 1 shown in FIG. 8A, similarly to the extractor shown in FIG. 7A, the interior of the temperature control chamber 3 is divided into an inner space 50 and an outer space 55 by the weir 21.

As indicated by the arrows in FIGS. 7A and 8A, temperature-controlled fluid can be introduced in multiple portions at time intervals. Fluid is first poured through the inlet 7 to the first position so as to fill the inner space 50, and after the extraction chamber 2 is heated to a desired temperature through the inner wall 20, fluid of the same or a different temperature can be successively supplied in such a manner that it overflows from the inner space 50 past the capacity of the weir and is introduced into the outer space 55. By thus displacing and replacing the fluid in the inner space 50, and by repeating additional supply up to a second position in multiple steps, it is possible to control the temperature of extraction chamber 2 in multiple stages.

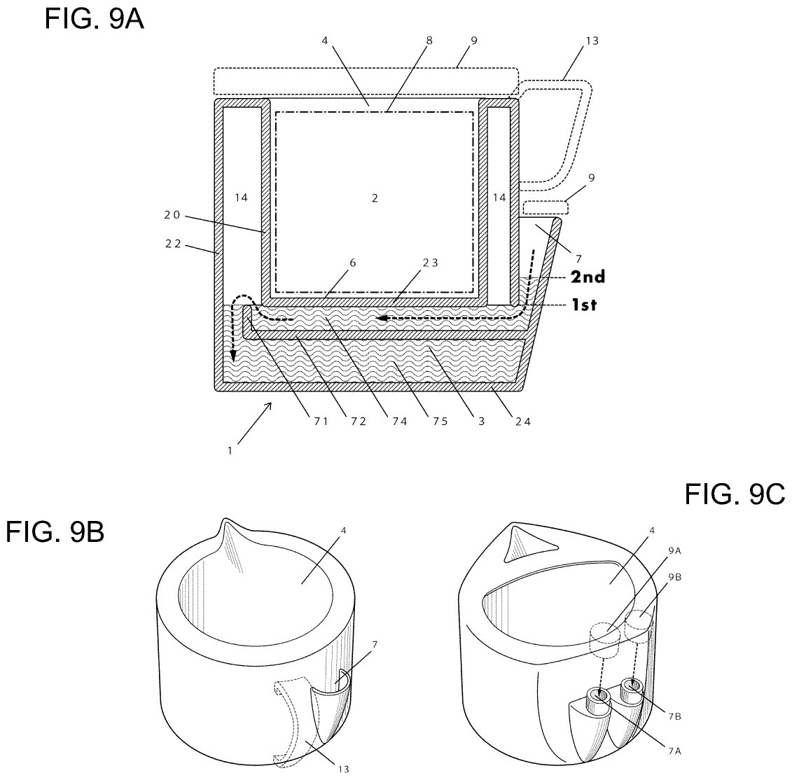

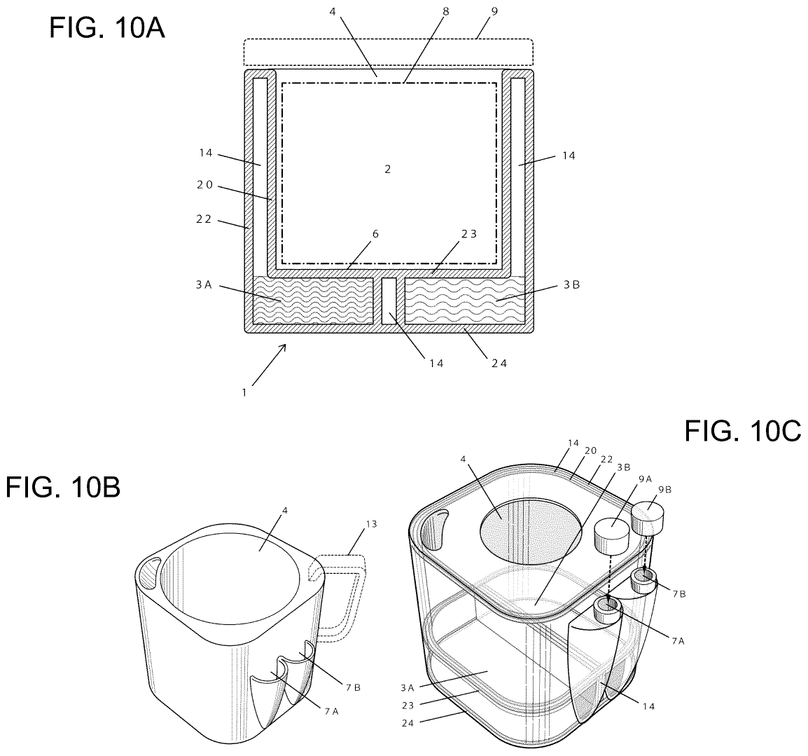

FIGS. 9A and 10A show extractors without extraction holes for discharging the extracted liquid, each comprising an extraction chamber 2 and a temperature control chamber 3, with the bottom surface (inner bottom wall 23) of the extraction chamber 2 serving as a partition wall, and the chambers being adjacent to each other. These are embodiments of immersion-type extractors for coffee, black tea, herbal tea, and the like, in which the space between the inner bottom wall 23 and the outer bottom wall 24 forms the temperature control chamber 3. The space 14 between the inner wall 20 and the outer wall 22 may be sealed and partitioned from the temperature control chamber 3 or may be continuous without a partition, functioning as an insulation space.

Moreover, FIGS. 9A-9C illustrate an embodiment in which the temperature control chamber 3 is located adjacent to the bottom wall 23 of extraction chamber 2, which serves as a partition, and is provided with an intermediate wall 72 and a weir 71 extending upward from the tip of the intermediate wall as partitions. The temperature control chamber 3 is divided by the intermediate wall 72 into an upper space (inside space of the weir) 74 and a lower space (outside space of the weir) 75. As indicated by the arrows in FIG. 9A, temperature-controlled fluid can be introduced multiple times at different intervals. First, fluid is introduced through inlet 7 formed in the outer wall 22 to the first position, thereby filling the upper space (inside space of the weir) 74, and after heating the extraction chamber 2 to a desired temperature via the inner bottom wall 23, fluid of the same or different temperature can be introduced multiple times so as to overflow from the upper space 74 beyond the weir's capacity, thereby displacing and replacing the fluid in the upper space 74 with fluid flowing into the lower space 75. By successively introducing fluid up to the second position, the temperature of the extraction chamber 2 can thus be controlled in multiple stages.

FIG. 10A shows a front view of a variant of the extractor of FIG. 9A, where the temperature control chamber 3 is divided into left and right independent spaces 3A and 3B in the planar direction. To homogenize the temperature in the extraction chamber 2 without mixing, the two temperature control chambers 3A and 3B may be filled with temperature adjusting medium at different high and low temperatures, or the same medium may be introduced at different times, allowing extended temperature control. Inlets 7A and 7B are provided for each temperature control chamber. The space 14 between chambers 3A and 3B serves as an insulation space preventing thermal interference.

Since the temperature control chamber 3 can be equipped in any extraction chamber 2 according to the purpose, the extractor 1 according to this application is not limited to the shapes (external and internal) or types of filters 8, numbers, sizes, or shapes of extraction holes 5 illustrated in FIGS. 1A to 11C. The basic plan views of the top and bottom surfaces are roughly circular but may also be polygonal or irregular.

The extractor 1 of the present invention may be integrally formed from a single material or formed by combining parts made of different materials such as metal and resin. For example, the partition walls between the extraction chamber 2 and temperature control chamber 3-i.e., the peripheral and bottom walls forming the extraction chamber 2—preferably comprise heat-conductive metal walls or thin walls with low specific heat to allow mutual heat transfer, while the outer walls of the temperature control chamber 3 exposed to ambient air are preferably made of low thermal conductivity materials such as resin to reduce adverse effects like heat loss by diffusion. Suitable materials for the partition walls include metals such as copper or stainless steel, and reinforced ceramics or fine ceramics. The modular construction by combining parts of different materials allows enjoyment of various combinations of shapes, materials, and colors.

As illustrated in FIGS. 3A, 4A, 9A, and 10A, installing lids 9 on openings of the pouring inlet 4 and the introduction inlet 7, where heat diffusion is likely to occur, is effective in preventing heat loss and contamination. The shapes of the pouring inlet 4 and introduction inlet 7 are arbitrary. The pouring inlet 4 may be circular like a conventional coffee dripper or polygonal. The introduction inlet 7, used for introducing the temperature adjusting medium such as heated water or ice, can be of any shape to suit the extraction purpose or usage such as camping. It may partially or completely encircle the extraction chamber 2, and it can be completely sealed while maintaining the medium inside, allowing for microwave heating or other heating methods.

As shown in FIGS. 1A, 2A, 6A, 7A, and 9A, narrowing the opening between the introduction inlet 7 and the temperature control chamber 3 is effective in preventing heat from diffusing outside the temperature control chamber 3.

Although specific embodiments of the extractor of the present invention have been illustrated, various modifications are conceivable. For example, making the outer wall of the temperature control chamber 3 from transparent resin allows easy visual confirmation of the extract dripping.

As illustrated in FIG. 3A, a stopper leg 10 may be added to prevent falling

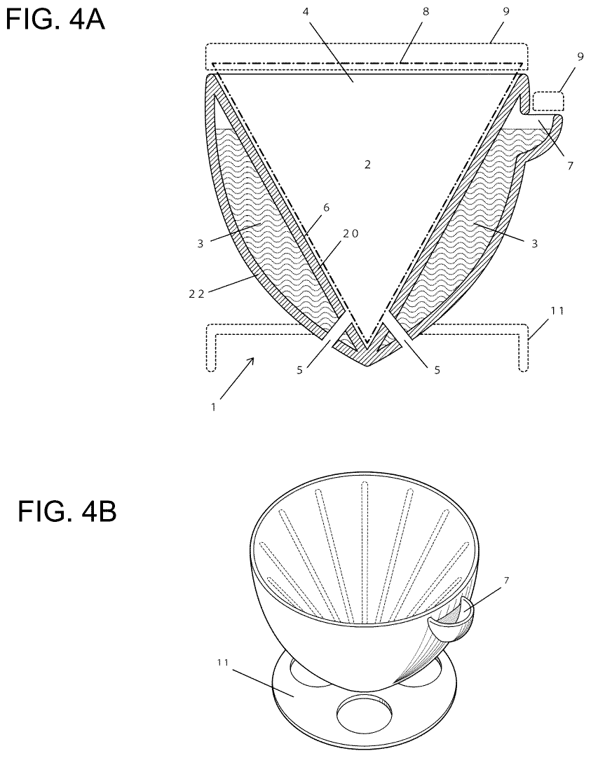

As shown in FIGS. 4A and 4B, a flange 11 may be added to stabilize installation.

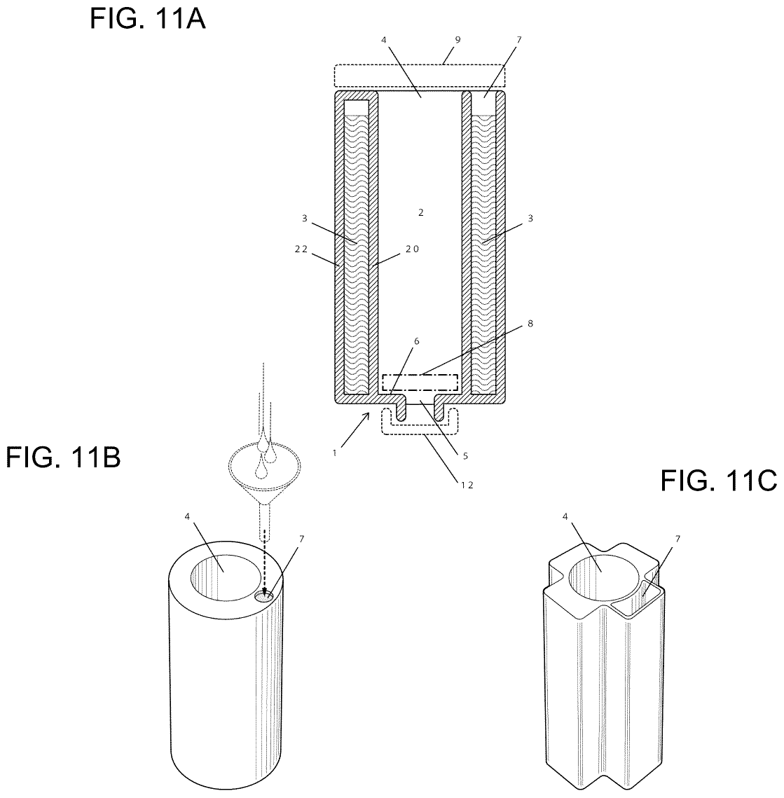

As illustrated in FIGS. 6A and 11A, a closable extraction hole plug 12 may be added.

As shown in FIGS. 6A and 6B and 7A-7C, a closable discharge hole 15 and a discharge hole plug 16 may be added to the temperature control chamber.

As shown in FIG. 9A, a handle 13 may be added.

As illustrated in FIGS. 9A and 10A, combining the insulation space 14 and the temperature control chamber 3 prevents heat loss.

As shown in FIGS. 3A, 6A, and 7A, the temperature control chamber 3 may include a small heater 17 for temperature control. This enables repeated continuous extraction without changing the temperature controlling water or fluid, allowing shorter extraction time in a stable extraction environment with optimal temperature control. Compared to traditional water baths, the temperature control chamber 3 to be heated is very small, enabling energy-saving operation and further cost reduction. Battery use enables operation in locations without power supply or outdoors.

A thermometer 18 for confirming the temperature inside the temperature control chamber 3 and a display panel 19 showing the measurement values may be installed on the outer wall 22, as in FIGS. 3A, 6A, and 7A. The thermometer 18 allows visualization of whether the temperature control chamber 3 is ideally controlled relative to the heated water temperature introduced into the extraction chamber 2. Any type of thermometer may be used, such as digital displays or film-type showing temperature by color. Additionally, as in FIG. 3C, electronic displays showing extraction method information, recipes including pouring water volume and timing, or extraction material information may be provided as the display panel.

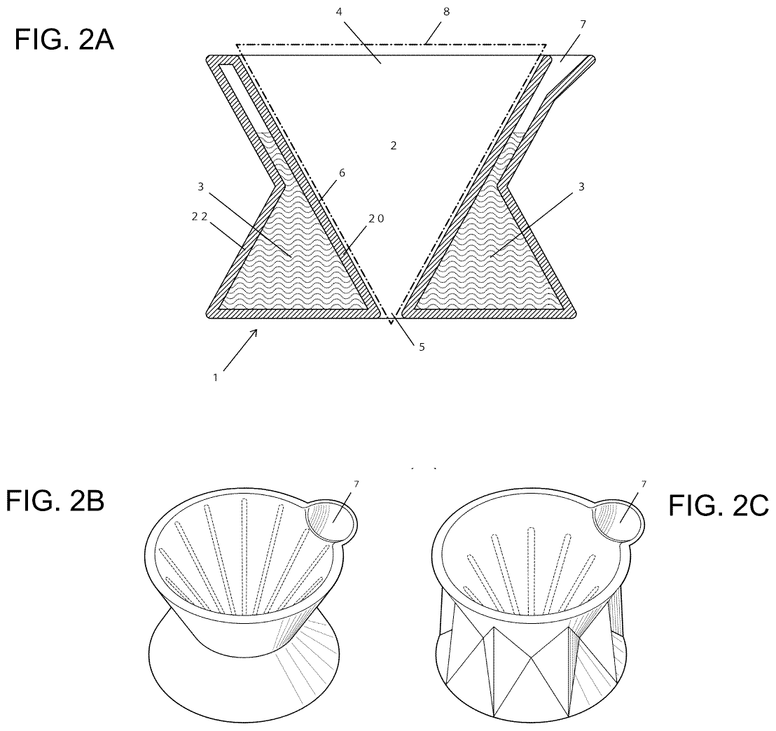

FIGS. 1A to 11C illustrate specific explanatory diagrams showing the distinctive mechanism of the present invention. In each numbered figure, (a) is a schematic vertical cross-sectional view, and (b) is a perspective view of an embodiment. These diagrams illustrate examples explaining the invention, and in practice, countless structural variations are possible to accommodate different purposes or materials while maintaining temperature control functions. For example, as shown in the perspective view of the trapezoidal type extractor in FIG. 1C, the outer wall 22 may be modified into any shape without impairing the temperature control function. FIG. 2A shows a conical-type extractor where the outer wall 22 narrows at its vertical midpoint to reduce the amount of temperature adjusting medium introduced into the temperature control chamber 3. As illustrated in the perspective view in FIG. 2C, columnar projections with reduced contact area may be provided to enable handling while hot.

Similarly, as in the perspective view of FIG. 3C, the extractor 1's outer shape may be a prism rather than a cylinder as shown in FIG. 3B. In this case, the inlet 7 may be positioned at the corners of the prism as shown in FIG. 3C. Different outer shapes using the same extraction chamber 2 as in FIG. 5B are also possible, as shown in the perspective view of FIG. 5C.
Because the temperature control chamber 3 conducts heat regardless of its deformation form, the outer shape is free and does not impair the temperature regulation function.
Moreover, differences in the presence or absence of temperature control chamber division as well as the number of inlets in each temperature control chamber distinguish the outer shapes shown in FIGS. 9B and 9C. FIGS. 10B and 10C show similar outer shapes, both allowing temperature adjusting medium to be introduced in successive stages, but differ by the circular or square shape of the extraction chamber 2 within.
As illustrated in the perspective view in FIG. 7C, the lower outer shape of the extractor 1 may be a hexagram or other shape rather than a cylinder, as seen in FIG. 7B. This reduces the amount of temperature adjusting medium introduced into the temperature control chamber 3, contributing to lower energy and resource consumption, such as water and heating costs, when temperature adjusting medium like water or fluids are used.
The example in the perspective view of FIG. 11C shows an extractor 1 with a cross-shaped prism cross-section instead of the cylindrical outer shape of FIG. 11B. The inlet 7 may have any shape as long as temperature adjusting medium can be introduced into the temperature control chamber 3; if small size makes introduction difficult, an auxiliary tool such as a funnel, shown in FIG. 11B, may be used.

The embodiments of the present invention have been described as beverage extractors, but the invention is also applicable to extraction or filtration of liquids containing solid materials such as cooking soups or oils, not limited to coffee or teas.

What is claimed is:

1. A beverage extractor comprising:
an extraction chamber through which liquid passes in order to extract components from an extraction material;
a temperature control chamber disposed adjacent to the outside of at least one of a side wall, a bottom wall, or a top wall defining the extraction chamber as a partition wall,
wherein the temperature control chamber surrounds the extraction chamber, and a bowl-shaped weir partition is provided in a planar direction, concentrically with respect to the extraction chamber, and the temperature control chamber is divided by the weir into an inner space and an outer space.

2. The beverage extractor according to claim 1, wherein, after a temperature adjusting medium introduced into the temperature control chamber fills the inner space, when the capacity of the inner space is exceeded and the medium further overflows, it moves into the outer space, whereby the temperature in the extraction chamber is adjusted during an extraction process.

3. The beverage extractor according to claim 1, wherein an inlet for introducing the temperature adjusting medium is provided in the temperature control chamber.

4. The beverage extractor according to claim 1, comprising multiple temperature control chambers, enabling the introduction of multiple temperature adjusting media at different temperatures, or the introduction of the same temperature adjusting medium at different times.

5. The beverage extractor according to claim 1, wherein the extraction material is ground coffee, the temperature adjusting medium is heated water, and the extraction chamber functions as a coffee filter holder.

6. The beverage extractor according to claim 1, further comprising a thermometer for displaying the temperature inside the temperature control chamber and an electronic display panel mounted on the outer wall for displaying information relating to extraction methods and extraction materials, including recipes indicating the amount and timing of pouring water.

7. The beverage extractor according to claim 1, wherein the side wall defining the extraction chamber serves as the partition wall with the temperature control chamber, and an outer wall of the beverage extractor is disposed so as to surround the partition wall, wherein the weir has a height lower than that of the partition wall.

8. The beverage extractor according to claim 7, wherein the side wall defining the extraction chamber and the outer wall of the beverage extractor are connected together at the upper part thereof.

9. The beverage extractor according to claim 7, wherein the side wall defining the extraction chamber is higher than the outer wall of the beverage extractor.

10. The beverage extractor according to claim 1, wherein the bottom wall defining the extraction chamber serves as the partition wall with the temperature control chamber, and an intermediate wall is formed below this partition wall and above an outer bottom wall of the beverage extractor, and the weir is provided on the intermediate wall.
